(19) United States
(12) Patent Application Publication
(10) Pub. No.: US 2026/0153644 A1
(43) Pub. Date: Jun. 4, 2026

(54) METHOD FOR RAPID RISK ASSESSMENT OF TIME-DELAYED ROCKBURST IN OPEN TBM TUNNEL

(71) Applicant: NORTHEASTERN UNIVERSITY, Shenyang, Liaoning (CN)

(72) Inventors: Zhibin YAO, Shenyang, Liaoning (CN); Xiating FENG, Shenyang, Liaoning (CN); Yongrun XIONG, Shenyang, Liaoning (CN); Wei ZHANG, Shenyang, Liaoning (CN); Lei HU, Shenyang, Liaoning (CN); Yu ZHANG, Shenyang, Liaoning (CN); Lianjie FU, Shenyang, Liaoning (CN); Song CHEN, Shenyang, Liaoning (CN)

(21) Appl. No.: 18/996,283

(22) PCT Filed: Jun. 14, 2024
(86) PCT No.: PCT/CN2024/099161

§ 371 Date: Jan. 17, 2025

(30) Foreign Application Priority Data
Feb. 27, 2024 (CN) 202410216654.1

(51) Int. Cl. G01V 11/00; E21D 9/00

(52) U.S. Cl. CPC G01V 11/002; E21D 9/003

(57) ABSTRACT

A method for risk assessment of time-delayed rockburst in open TBM tunnel includes steps of: determining a range of a time-delayed rockburst risk assessment unit; acquiring and collating TBM parameters of the risk assessment unit; classifying the risk assessment unit that meets TBM parameter variation characteristic conditions as a time-delayed rockburst risk zone; obtaining a tunnel site topographic map and geological data of the tunnel, and advanced geological prediction results of an unexcavated area, and analyzing for any special geological structure zone; acquiring support data of an excavated area and analyzing a control effect of support means; calculating probabilities of the time-delayed rockburst to create a time-delayed rockburst probability table; and substituting analysis results of the support means for the time-delayed rockburst risk zone and the special geological structure zone into the probability table to obtain a probability of the time-delayed rockburst in the time-delayed rockburst risk zone.

### TECHNICAL FIELD

The present disclosure relates to the technical field of rockburst risk assessment, and in particular to a method for rapid risk assessment of time-delayed rockburst in an open TBM tunnel.

### BACKGROUND

A time-delayed rockburst refers to a rockburst that occurs under the action of external disturbance after excavation unloading and stress adjustment and balancing, and has characteristics of spatio-temporal delay or time delay. During TBM tunnel construction, due to structural limitations of TBM itself, if a time-delayed rockburst risk zone is not identified in time at an initial stage when a surrounding rock is exposed from a tail part of shield, it will be very difficult to treat the time-delayed rockburst zone later, which poses significant challenges and difficulties to engineering construction and disaster prevention and control. Therefore, a method for timely and efficient risk assessment of time-delayed rockburst is particularly important.

The patent application CN115165629A discloses a method for evaluating rockburst type tendency. The method calculates, based on residual elastic energy and rockburst ejection critical energy of a rock sample obtained in a test, an energy ratio for potential rockbursts type evaluation, and determine a tendency of rockburst type according to a value of the energy ratio for potential rockbursts type evaluation; and when ω≥1, it is determined that there is a tendency of immediate rockburst, and when ω<1, it is determined that there is a tendency of time-delayed rockburst or there is no tendency of rockburst. The method evaluates the tendency of time-delayed rockburst of rock from an energy perspective, but ignores an effect of a rock mass structure on the time-delayed rockburst.

The patent application CN110568477A discloses a spatio-temporal early warning method against time-delayed type rockburst in tunnel construction. The method arranges a microseismic sensors in a tunnel and connects them to a microseismic monitoring system, positions a microseismic event collected to obtain a pile number range and location corresponding to a rockburst risk zone, and then arranges a plurality of stress sensors in the rockburst risk zone. The method can finally obtain microseismic parameters and stress evolution curves of the rockburst risk zone, thereby analyzing and determining a position and moment of rockburst. The application is capable of achieving accurate early warning of the position and moment of rockburst. However, microseismic monitoring is not carried out for many tunnel projects with the time-delayed rockburst risks in a timely manner, and it is difficult to apply the method of the application directly.

The patent application CN116088033A discloses a time-delay extremely-strong rockburst geological determination method. The method establishes a corresponding three-dimensional numerical calculation model according to an initial crustal stress test result and physical and mechanical parameters of rocks and structural planes obtained by on-site geological survey, and perform numerical calculation, through tunnel excavation simulation under different structural plane combination conditions, to judge the risk of a time-delay extremely-strong rockburst disaster after excavation of the current position of a tunnel. The application takes into account an effect of structural planes and combinations thereof on time-delayed rockburst, but it is difficult to directly obtain the needed physical and mechanical parameters.

To sum up, for time-delayed rockburst risk assessment, a method for rapid risk assessment of time-delayed rockburst in an open TBM tunnel based on multi-source information that can be directly obtained on site has not been established yet.

### SUMMARY

To solve the above technical problems, a method for rapid risk assessment of time-delayed rockburst in an open TBM tunnel is provided in the present disclosure.

The technical means employed by the present disclosure are as follows:

A method for rapid assessment of time-delayed rockburst risk in an open TBM tunnel, specifically including the following steps:
S1, recording a distribution of immediate high-stress failures in an excavated tunnel section and determining a range of a time-delayed rockburst risk assessment unit;
S2, acquiring and collating TBM parameters of the time-delayed rockburst risk assessment unit;
S3, classifying the risk assessment unit that meets TBM parameter variation characteristic conditions as a time-delayed rockburst risk zone;
S4, obtaining a topographic map of a tunnel site, geological data of the tunnel, and advanced geological prediction results of an unexcavated area, and analyzing whether there is any special geological structure zone within three times a tunnel diameter of the time-delayed rockburst risk zone;
S5, acquiring support data of an excavated area and analyzing a control effect of support means on rockburst in the time-delayed rockburst risk zone;
S6, calculating probabilities of the time-delayed rockburst under different conditions according to an influence of the special geological structure zone and support means of a similar project on the time-delayed rockburst in an open TBM tunnel, and creating a time-delayed rockburst probability table; and
S7, substituting analysis results of the support means for the time-delayed rockburst risk zone and the special geological structure zone into the time-delayed rockburst probability table to obtain a probability of the time-delayed rockburst in the time-delayed rockburst risk zone.

Further, in step S1, the immediate high-stress failure refers to a high-stress failure that occurs within a range of three times the tunnel diameter from a tunnel face, comprising immediate rockburst, immediate spalling and immediate stress-induced collapse.

The range of the time-delayed rockburst risk assessment unit is a range from one time the tunnel diameter behind a rear boundary of the immediate high-stress failure zone to one time the tunnel diameter in front of a front boundary thereof.

Further, in step S2, the TBM parameters include total thrust, penetration and cutterhead torque.

Further, in step S3, the TBM parameter variation characteristics comprise overall size, fluctuation degree and variation amplitude, wherein the overall size is described by means of an average value, the fluctuation degree is described by means of a standard deviation, and the variation amplitude is described by means of a range.

Further, in step S5, the support means comprise no support, anchor-net support, steel arch & anchor rod support, anchor-net shotcrete support, and steel arch & anchor-net shotcrete support, and corresponding support levels are level 0, level 1, level 2, level 3, level 4 and level 5, respectively; and when the support means do not meet specifications or a support strength is insufficient, the support level is downgraded.

Further, in step S6, the probability of the time-delayed rockburst is expressed as P; and
When the support level of the time-delayed rockburst risk zone is not lower than a highest support level of the risk zone or its adjacent immediate rockburst zone, and there is no special geological structure zone within a range of three times the tunnel diameter of the time-delayed rockburst risk zone, the probability of the time-delayed rockburst is expressed as P₁;
When the support level of the time-delayed rockburst risk zone is not lower than a highest support level of the risk or an adjacent immediate rockburst zone, and there is a special geological structure zone within a range of three times the tunnel diameter of the time-delayed rockburst risk zone, the probability of the time-delayed rockburst is expressed as P₂;
When the support level of the time-delayed rockburst risk zone is lower than a highest support level of the risk zone or its adjacent immediate rockburst zone, and there is no special geological structure zone within a range of three times the tunnel diameter of the time-delayed rockburst risk zone, the probability of the time-delayed rockburst is expressed as P₃; and
When the support level of the time-delayed rockburst risk zone is lower than a highest support level of the risk zone or its adjacent immediate rockburst zone, and there is a special geological structure zone within a range of three times the tunnel diameter of the time-delayed rockburst risk zone, the probability of the time-delayed rockburst is expressed as P₄.

Further, a storage medium is provided in the present disclosure. The storage medium includes a stored program, where the method for rapid risk assessment of time-delayed rockburst in an open TBM tunnel is implemented when the program is executed.

Further, an electronic device is provided in the present disclosure. The electronic device includes a memory, a processor, and a computer program stored in the memory and executable on the processor, where the processor, through execution of the computer program, implements the method for rapid risk assessment of time-delayed rockburst in an open TBM tunnel.

Compared with the prior art, the present disclosure has the following advantages:

The present disclosure provides a method for rapid risk assessment of time-delayed rockburst in an open TBM tunnel, which neither requires testing of crustal stress and protolith mechanical properties, nor requires microseismic monitoring or acoustic emission monitoring. Risk assessment indicators of the present disclosure include immediate high-stress failure information, TBM parameters, on-site geological and support data, which can be easily obtained. The present disclosure achieves the rapid assessment of a risk section and risk probability of the time-delayed rockburst in an open TBM tunnel, provides a scientific basis for taking targeted prevention and control measures, and effectively avoids or reduces the risk of the time-delayed rockburst, thereby ensuring construction safety of the open TBM tunnel.

Based on the above reasons, the present disclosure can be widely promoted in the field of rockburst risk assessment.

### BRIEF DESCRIPTION OF THE DRAWINGS

The drawings used in the embodiments or the prior art will be briefly described herein to more clearly describe the embodiments of the present application or the technical solutions in the prior art. Apparently, the following described drawings are merely some embodiments of the present disclosure. For those ordinary skilled in the art, other drawings can also be obtained according to the provided drawings without creative work.

FIG. 1 is a flowchart of a method for rapid risk assessment of time-delayed rockburst in an open TBM tunnel according to the present disclosure.

FIG. 2 is a layout diagram of immediate failures of sections K54+170 to K54+270 according to an example of the present disclosure.

FIG. 3 is a curve of TBM parameters of sections K54+170 to K54+270 changing with a tunnel mileage according to an example of the present disclosure.

FIG. 4 is a schematic diagram of a spatial relation between a time-delayed rockburst risk zone and a fault according to an example of the present disclosure.

FIG. 5 is a layout diagram of initial support means of sections K54+170 to K54+270 according to an example of the present disclosure.

FIG. 6 is a practical situation diagram of a time-delayed rockburst according to an example of the present disclosure.

### DETAILED DESCRIPTIONS OF THE EMBODIMENTS

In order to enable those skilled in the art to better understand the present disclosure, the following clearly and completely describes the technical solutions in the embodiments of the present disclosure with reference to the accompanying drawings in the embodiments of the present disclosure. Apparently, the described embodiments are merely some rather than all of the embodiments. Based on the embodiments of the present disclosure, all the other embodiments obtained by those of ordinary skill in the art without inventive effort are within the protection scope of the present disclosure.

It should be noted that the terms “first” and “second” in the description and claims of the present application and the above drawings are for the purpose of distinguishing similar objects, rather than describing a specific sequence or order. It should be understood that the terms so used are interchangeable under appropriate circumstances such that the embodiments of the present application described herein can be practiced in sequences different from those illustrated or described herein. Moreover, the terms such as “comprise”, “have” or any other variants thereof are intended to be non-exclusive. For example, a process, method, system, product or apparatus including a series of steps or elements comprises not only the expressly listed steps or elements but also other steps or elements that are not enumerated or are inherent for the process, method, system, product or apparatus.

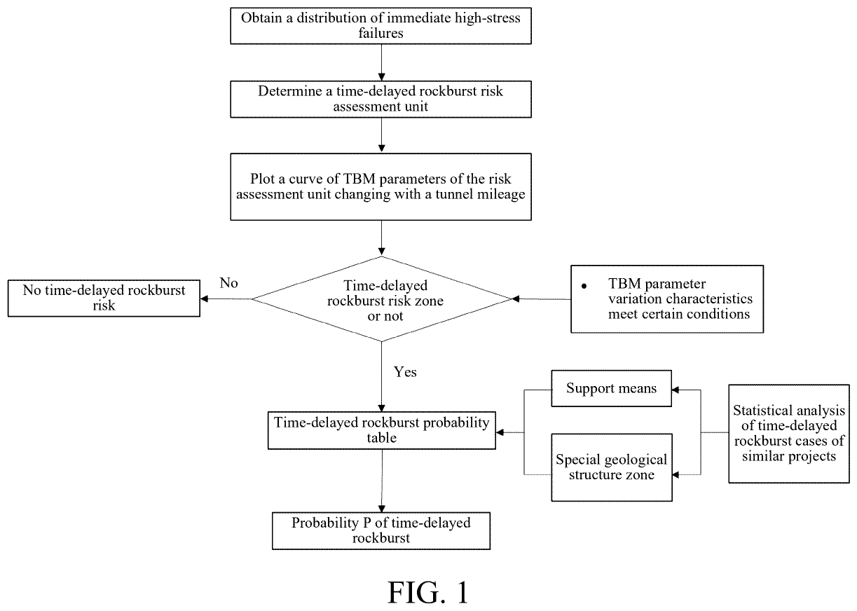

As shown in FIG. 1, the present disclosure provides a method for rapid risk assessment of time-delayed rockburst in an open TBM tunnel, and the method specifically includes the following steps of:
S1, recording a distribution of immediate high-stress failures in an excavated tunnel section and determining a range of a time-delayed rockburst risk assessment unit;
S2, acquiring and collating TBM parameters of the time-delayed rockburst risk assessment unit;
S3, classifying the risk assessment unit that meets TBM parameter variation characteristic conditions as a time-delayed rockburst risk zone;
S4, obtaining a tunnel site topographic map of the tunnel, geological data of the tunnel, and advanced geological prediction results of an unexcavated area, and analyzing whether there is any special geological structure zone within three times a tunnel diameter of the time-delayed rockburst risk zone;
S5, acquiring support data of an excavated area and analyzing a control effect of support means on rockburst in the time-delayed rockburst risk zone;
S6, calculating, according to an influence of the special geological structure zone and support means of a similar project on the time-delayed rockburst in an open TBM tunnel, probabilities of the time-delayed rockburst under different conditions, and creating a time-delayed rockburst probability table; and
S7, substituting analysis results of the support means for the time-delayed rockburst risk zone and the special geological structure zone into the time-delayed rockburst probability table to obtain a probability of the time-delayed rockburst in the time-delayed rockburst risk zone.

In one implementation, as a preferred embodiment of the present disclosure, in step S1, the immediate high-stress failure refers to a high-stress failure that occurs within a range of three times the tunnel diameter from a tunnel face, comprising immediate rockburst, immediate spalling and immediate stress-induced collapse.

The range of the time-delayed rockburst risk assessment unit is a range from one time the tunnel diameter behind a rear boundary of the immediate high-stress failure zone to one time the tunnel diameter in front of a front boundary thereof.

In one implementation, as a preferred embodiment of the present disclosure, in step S2, the TBM parameters include total thrust, penetration rate and cutterhead torque.

In one implementation, as a preferred embodiment of the present disclosure, in step S3, the TBM parameter variation characteristics include overall size, fluctuation degree and variation amplitude, where the overall size is described by means of an average value, the fluctuation degree is described by means of a standard deviation, and the variation amplitude is described by means of a range.

In implementation, the special geological structure zone includes a river valley stress zone, an area with significant surface undulations, an area with faults, folds or extended mineral strips, or an area with an alteration zone, etc.;

In one implementation, as a preferred embodiment of the present disclosure, in step S5, the support means include no support, anchor-net support, steel arch & anchor rod support, anchor-net shotcrete support, and steel arch & anchor-net shotcrete support, and corresponding support levels are level 0, level 1, level 2, level 3, level 4 and level 5, respectively; and when the support means do not meet specifications or a support strength is insufficient, such as an insufficient number of anchor rods, an insufficient thickness of concrete spray layer, and the like, the support level needs to be downgraded.

In one implementation, as a preferred embodiment of the present disclosure, in step S6, the probability of the time-delayed rockburst is expressed as P; and
When the support level of the time-delayed rockburst risk zone is not lower than a highest support level of the risk zone or its adjacent immediate rockburst zone, and there is no special geological structure zone within a range of three times the tunnel diameter of the time-delayed rockburst risk zone, the probability of the time-delayed rockburst is expressed as P₁;
When the support level of the time-delayed rockburst risk zone is not lower than a highest support level of the risk zone or its adjacent immediate rockburst zone, and there is a special geological structure zone within a range of three times the tunnel diameter of the time-delayed rockburst risk zone, the probability of the time-delayed rockburst is expressed as P₂;
When the support level of the time-delayed rockburst risk zone is lower than a highest support level of the risk zone or a its adjacent immediate rockburst zone, and there is no special geological structure zone within a range of three times the tunnel diameter of the time-delayed rockburst risk zone, the probability of the time-delayed rockburst is expressed as P₃; and
When the support level of the time-delayed rockburst risk zone is lower than a highest support level of the risk zone or its adjacent immediate rockburst zone, and there is a special geological structure zone within a range of three times the tunnel diameter of the time-delayed rockburst risk zone, the probability of the time-delayed rockburst is expressed as P₄.

In one implementation, the time-delayed rockburst probability table is shown in Table 1:

TABLE 1
Time-delayed rockburst probability table

| | there is no special | there is a special |
|---|---|---|
| | geological structure | geological structure |
| | zone within a range | zone within a range |
| | of three times the | of three times the |
| | tunnel diameter of | tunnel diameter of |
| | the time-delayed | the time-delayed |
| | rockburst risk zone | rockburst risk zone |
| The support level of the | P = P₁ | P = P₂ |
| time-delayed rockburst | | |
| risk zone is not lower | | |
| than a highest support | | |
| level of the risk zone | | |
| or its adjacent immediate | | |
| rockburst zone | | |
| the support level of the | P = P₃ | P = P₄ |
| time-delayed rockburst | | |
| risk zone is lower | | |
| than a highest support | | |
| level of the risk zone | | |
| or its adjacent immediate | | |
| rockburst zone | | |

P₁, P₂, P₃ and P₄ are specific probability values of the time-delayed rockburst under corresponding conditions, which can be obtained according to the influence of the special geological structure zone and support means of a similar project on the time-delayed rockburst in an open TBM tunnel.

In one implementation, as a preferred embodiment of the present disclosure, a storage medium including a stored program is provided, where the method for rapid risk assessment of time-delayed rockburst in an open TBM tunnel is implemented when the program is executed.

In one implementation, as a preferred embodiment of the present disclosure, an electronic device including a memory, a processor, and an computer program stored in the memory and executable on the processor is provided, where the processor, through execution of the computer program, implements the method for rapid risk assessment of time-delayed rockburst in an open TBM tunnel.

### Example

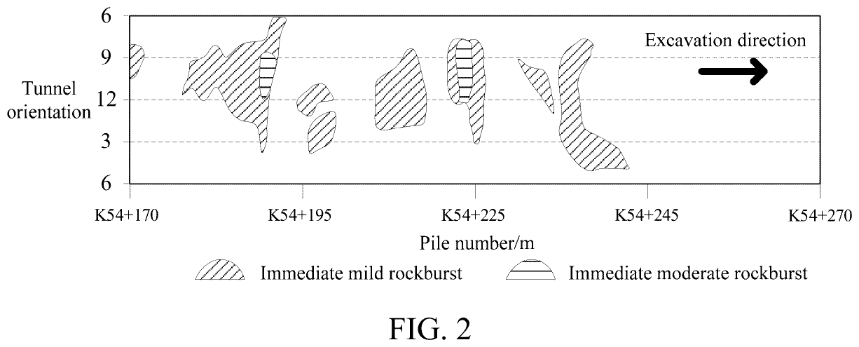

As illustrated in FIG. 1, the present disclosure provides a method for rapid risk assessment of time-delayed rockburst in an open TBM tunnel. Taking an open TBM tunnel as an example, the tunnel has a circular cross section with a diameter of 7.0 m, and is primarily composed of Carboniferous tuff. Taking sections K54+170 to K54+270 as an analysis case, a distribution of immediate high-stress failures that occur during excavation of the sections is recorded, as illustrated in FIG. 2. It can be seen from FIG. 2 that the immediate high-stress failures of the sections K54+170 to K54+270 mainly include the immediate rockburst, and a rockburst level is mild and moderate. A range of each immediate rockburst crater from 7 m behind a rear boundary thereof to 7 m in front of a front boundary thereof is defined as a time-delayed rockburst risk assessment unit. The time-delayed rockburst risk assessment units are classified from small to large according to tunnel mileage as K54+170 to K54+179, K54+171 to K54+197, K54+186.5 to K54+206, K54+199 to K54+213, K54+209.5 to K54+229, K54+220.5 to K54+238, and K54+224 to K54+249.

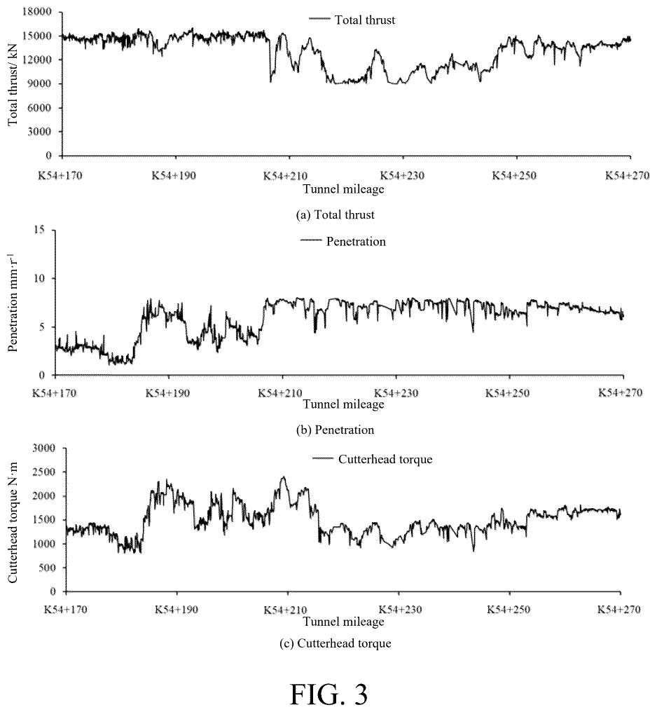

TBM parameters of each time-delayed rockburst assessment unit are obtained, data generated in processes of TBM startup, TBM shutdown, and TBM excavation stop are excluded, and finally, a curve of the TBM parameters changing with a tunnel mileage is plotted, as shown in FIG. 3.

The average value, standard deviation and range of the TBM parameters in each time-delayed rockburst risk assessment unit are calculated by step S4, and the results are shown in Table 2.

TABLE 2
Calculated results of TBM parameter variation characteristics

| | Total thrust/kN | | | Penetration/mm · r⁻¹ | | | Cutterhead torque/N · m | | |
|---|---|---|---|---|---|---|---|---|---|
| | Average | Standard | | Average | Standard | | Average | Standard | |
| Assessment unit | value | deviation | range | value | deviation | range | value | deviation | range |
| K54 + 170 to | 14721.4 | 347.1 | 2220.2 | 2.8 | 0.4 | 2.8 | 1298 | 79.6 | 412.7 |
| K54 + 179 | | | | | | | | | |
| K54 + 171 to | 14742.6 | 487.6 | 3611.1 | 3 | 1.5 | 6.9 | 1335.8 | 347.6 | 1545.8 |
| K54 + 197 | | | | | | | | | |
| K54 + 186.5 to | 14929 | 523.9 | 3611.2 | 4.5 | 1.2 | 5.6 | 1670.2 | 254 | 1165.2 |
| K54 + 206 | | | | | | | | | |
| K54 + 199 to | 14437.4 | 1434.3 | 6570.4 | 5 | 1.5 | 5 | 1714.3 | 254 | 1100.2 |
| K54 + 212 | | | | | | | | | |
| K54 + 209.5 to | 11134.2 | 1617.9 | 5820 | 7.1 | 0.7 | 3.6 | 1431.9 | 344 | 1424.5 |
| K54 + 229 | | | | | | | | | |
| K54 + 220.5 to | 10575.4 | 1100.3 | 4371 | 7.2 | 0.5 | 2.7 | 1268.9 | 149.1 | 607.7 |
| K54 + 238 | | | | | | | | | |
| K54 + 224 to | 11363.6 | 1288.7 | 5937.9 | 7.3 | 0.6 | 3.5 | 1338.1 | 144.1 | 914 |
| K54 + 249 | | | | | | | | | |

Statistical analysis of cases under similar conditions reveals that the TBM parameters of the time-delayed rockburst zone have characteristics of significant fluctuations, and specific indicator characteristics are as follows: an average value of total thrust is >14000 kN, a standard deviation of total thrust is >1200 kN, and a range of total thrust is >3000 kN; an average value of penetration is <6 mm·r⁻¹, a standard deviation of penetration is >1 mm·r⁻¹, and a range of penetration is >3 mm·r⁻¹; and an average value of cutterhead torque is >1500 N·m, a standard deviation of cutterhead torque is >200 N·m, and a range of cutterhead torque is >1000 N·m. When the TBM parameters of a time-delayed rockburst risk assessment unit have the above characteristics, the assessment unit is classified as a time-delayed rockburst risk zone. To sum up, sections K54+199 to K54+213 are classified as time-delayed rockburst risk zone, and other assessment units do not have the above characteristics.

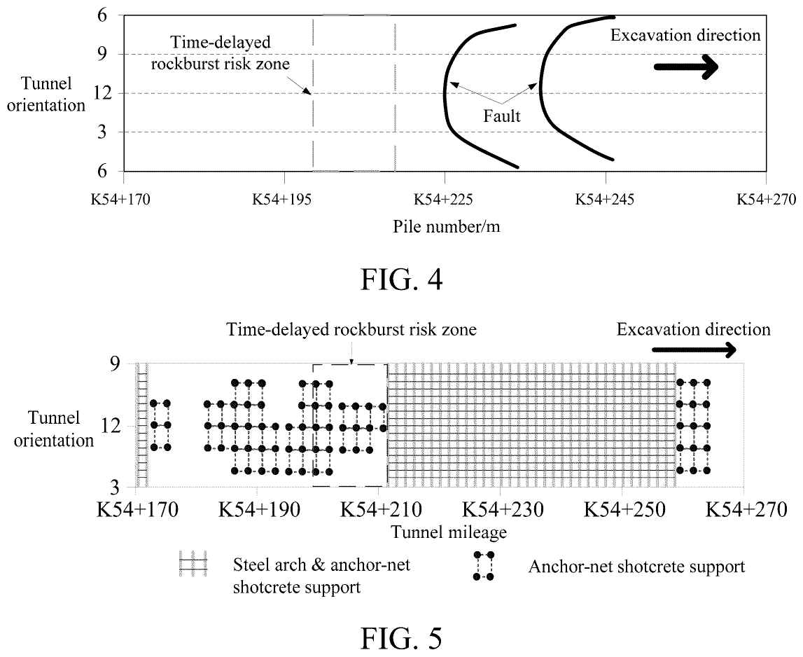

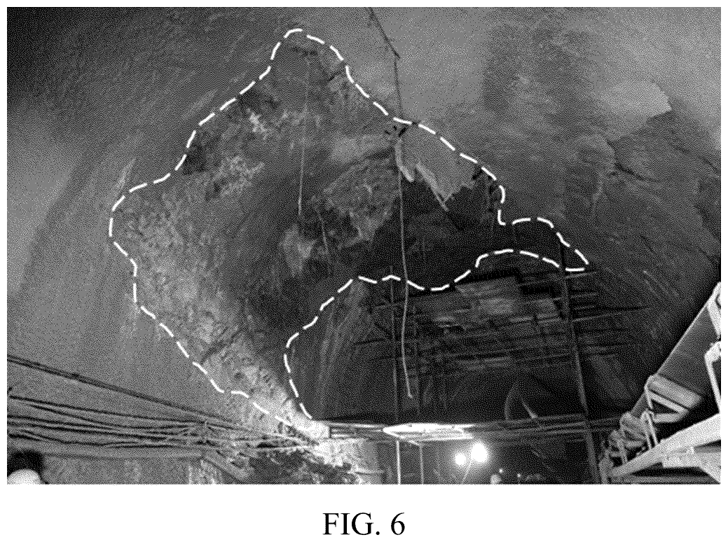

Analysis results of a topographic map of tunnel site and geological data of excavated area show that two nearly parallel faults are developed in the sections K54+222 to K54+250 near the sections K54+199 to K54+213, as shown in FIG. 4, indicating that there is a special geological structure zone near the time-delayed rockburst risk zone. Analysis results of support data of the excavated area show that anchor-net shotcrete support is adopted for the sections K54+199 to K54+213, and a corresponding support level is 4, but its support areas are randomly distributed and relatively insufficient, such that it needs to be downgraded, and the support level is finally determined to be level 3; and the highest support level of the risk zone or its adjacent immediate rockburst zone appears in sections K54+213 to K54+254, steel arch & anchor-net shotcrete support are adopted, and the corresponding support level is level 5, as shown in FIG. 5.

According to case statistics of similar projects, probabilities of the time-delayed rockburst under different conditions are calculated by analyzing an influence of the special geological structure zone and support means of a similar project on the time-delayed rockburst in an open TBM tunnel, and a time-delayed rockburst probability table is created, as shown in Table 3.

TABLE 3
Time-delayed rockburst probability table

| | there is no special | there is a special |
|---|---|---|
| | geological structure | geological structure |
| | zone within a range | zone within a range |
| | of three times the | of three times the |
| | tunnel diameter of | tunnel diameter of |
| | the time-delayed | the time-delayed |
| | rockburst risk zone | rockburst risk zone |
| the support level of the | P = 5% | P = 25% |
| time-delayed rockburst | | |
| risk zone is not lower | | |
| than a highest support | | |
| level of the risk zone | | |
| or its adjacent immediate | | |
| rockburst zone | | |
| the support level of the | P = 50% | P = 95% |
| time-delayed rockburst | | |
| risk zone is lower | | |
| than a highest support | | |
| level of the risk zone | | |
| or its adjacent immediate | | |
| rockburst zone | | |

Analysis results show that the support level of the time-delayed rockburst risk zone is lower than the highest support level of the risk zone or its adjacent immediate rockburst zone. It is comprehensively judged that the sections K54+199 to K54+213 are a time-delayed rockburst risk zone, and the probability P of time-delayed rockburst is 95%.

In a subsequent construction process, a time-delayed rockburst occurred in the sections K54+199 to K54+213 on Oct. 22, 2021, the excavating time of the sections was delayed by 94 days, the delay distance behind the tunnel face was 769 m, and a size of the rockburst pit was 13 m×6 m×1.2 m (length×width×depth), as shown in FIG. 6, indicating that the evaluation results are consistent with actual results.

The sequence numbers of the foregoing embodiments of the present disclosure are merely for the purpose of description, and do not indicate the preference of the embodiments.

In the foregoing embodiments of the present disclosure, the descriptions of the embodiments have respective focuses. For a part not described in detail in an embodiment, reference is made to related description of another embodiment.

In the embodiments of the present disclosure, it should be understood that the disclosed technical contents may be implemented in other manners. The embodiments for the device described above are only schematic. For example, the units may be classified based on logical functions. In actual implementation, the units may be classified in other manners. For example, a plurality of units or components may be combined or integrated into another system, or some features may be omitted or not executed. In addition, the coupling, or direct coupling, or communication connection between the shown or discussed components may be the indirect coupling or communication connection by means of some interfaces, units, or modules, and may be in electrical or other forms.

The units described as separate components may or may not be physically separated. The components shown as units may or may not be physical units, that is, the components may be located in one place, or may be distributed among a plurality of units. Some or all of the units may be selected as needed, to implement the technical solutions of the embodiments.

In addition, each functional unit in each embodiment of the present disclosure may be integrated in a processing unit or each unit may exist physically and separately, or two or more units may be integrated in a processing unit. The integrated unit described above may be implemented by hardware or software functional units.

When the integrated unit is implemented in the form of a software functional unit and sold or used as an independent product, the integrated unit may be stored in a computer-readable storage medium. Based on such understandings, the technical solutions of the present disclosure or a part of the technical solutions that makes contributions to the related art or all or a part of the technical solutions may be essentially embodied in the form of a software product. The computer software product is stored in a storage medium. The computer software product comprises a number of instructions that allow a computer device (which may be a personal computer, a server, a network device, or the like) to execute all or a part of the steps of the method in the embodiments of the present disclosure. The storage medium may comprise various media such as a U disk, a read-only memory (ROM), a random access memory (RAM), a removable hard disk, a magnetic disk, an optical disk or the like which can store program codes. The processor of the present disclosure may be a programmable computing processing device, including a microcontroller unit (MCU), a microprocessor unit (MPU), a digital signal processor (DSP), and a central processing unit (CPU).

Finally, it should be noted that the above various embodiments are merely intended to illustrate the technical solution of the present disclosure and not to limit the same; although the present disclosure has been described in detail with reference to the foregoing embodiments, it should be understood by those ordinary skilled in the art that the technical solutions described in the foregoing embodiments can be modified or equivalents can be substituted for some or all of the technical features thereof; and the modification or substitution does not make the essence of the corresponding technical solution deviate from the scope of the technical solution of each embodiment of the present disclosure.

1. A method for rapid risk assessment of time-delayed rockburst in open TBM tunnel, comprising the following steps of:
S1, recording a distribution of immediate high-stress failures in an excavated tunnel section and determining a range of a time-delayed rockburst risk assessment unit;
S2, acquiring and collating TBM parameters of the time-delayed rockburst risk assessment unit;
S3, classifying the risk assessment unit that meets TBM parameter variation characteristic conditions as a time-delayed rockburst risk zone;
S4, obtaining a tunnel site topographic map of the tunnel, geological data of the tunnel, and advanced geological prediction results of an unexcavated area, and analyzing whether there is any special geological structure zone within three times a tunnel diameter of the time-delayed rockburst risk zone;
S5, acquiring support data of an excavated area and analyzing a control effect of support means on rockburst in the time-delayed rockburst risk zone;
S6, calculating, according to an influence of the special geological structure zone and support means of a similar project on the time-delayed rockburst in an open TBM tunnel, probabilities of the time-delayed rockburst under different conditions, and creating a time-delayed rockburst probability table; and
S7, substituting analysis results of the support means for the time-delayed rockburst risk zone and the special geological structure zone into the time-delayed rockburst probability table to obtain a probability of the time-delayed rockburst in the time-delayed rockburst risk zone.

2. The method for rapid risk assessment of time-delayed rockburst in an open TBM tunnel according to claim 1, wherein in step S1, the immediate high-stress failure refers to a high-stress failure that occurs within a range of three times the tunnel diameter from a tunnel face, comprising immediate rockburst, immediate spalling and immediate stress-induced collapse; and
the range of the time-delayed rockburst risk assessment unit is a range from one time the tunnel diameter behind a rear boundary of the immediate high-stress failure zone to one time the tunnel diameter in front of a front boundary thereof.

3. The method for rapid risk assessment of time-delayed rockburst in an open TBM tunnel according to claim 1, wherein in step S2, the TBM parameters comprise total thrust, penetration and cutterhead torque.

4. The method for rapid risk assessment of time-delayed rockburst in an open TBM tunnel according to claim 1, wherein in step S3, the TBM parameter variation characteristics comprise overall size, fluctuation degree and variation amplitude, wherein the overall size is described by means of an average value, the fluctuation degree is described by means of a standard deviation, and the variation amplitude is described by means of a range.

5. The method for rapid risk assessment of time-delayed rockburst in an open TBM tunnel according to claim 1, wherein in step S5, the support means comprise no support, anchor-net support, steel arch & anchor rod support, anchor-net shotcrete support, and steel arch & anchor-net shotcrete support, and corresponding support levels are level 0, level 1, level 2, level 3, level 4 and level 5, respectively; and when the support means do not meet specifications or a support strength is insufficient, the support level is downgraded.

6. The method for rapid risk assessment of time-delayed rockburst in an open TBM tunnel according to claim 1, wherein in step S6, the probability of the time-delayed rockburst is expressed as P;
when the support level of the time-delayed rockburst risk zone is not lower than a highest support level of the risk zone or its adjacent immediate rockburst zone, and there is no special geological structure zone within a range of three times the tunnel diameter of the time-delayed rockburst risk zone, the probability of the time-delayed rockburst is expressed as P₁;
when the support level of the time-delayed rockburst risk zone is not lower than a highest support level of the risk or its adjacent immediate rockburst zone, and there is a special geological structure zone within a range of three times the tunnel diameter of the time-delayed rockburst risk zone, the probability of the time-delayed rockburst is expressed as P₂;
when the support level of the time-delayed rockburst risk zone is lower than a highest support level of the risk zone or its adjacent immediate rockburst zone, and there is no special geological structure zone within a range of three times the tunnel diameter of the time-delayed rockburst risk zone, the probability of the time-delayed rockburst is expressed as P₃; and
when the support level of the time-delayed rockburst risk zone is lower than a highest support level of the risk zone or its adjacent immediate rockburst zone, and there is a special geological structure zone within a range of three times the tunnel diameter of the time-delayed rockburst risk zone, the probability of the time-delayed rockburst is expressed as P₄.

7. A storage medium, comprising a stored program, wherein the method according to claim 1 is implemented when the program is executed.

8. An electronic device, comprising a memory, a processor, and a computer program stored in the memory and executable on the processor, wherein the processor, through execution of the computer program, implements the method according to claim 1.
